(19) United States
(12) Patent Application Publication
(10) Pub. No.: US 2012/0043762 A1
(43) Pub. Date: Feb. 23, 2012

(54) VARIABLE WINDMILL WING WIND POWER GENERATOR HAVING POWER GENERATION EFFICIENCY INCREASING MEANS

(76) Inventor: In-Nam LEE, Gyeonggi-do (KR)

(21) Appl. No.: 13/195,577

(22) Filed: Aug. 1, 2011

(30) Foreign Application Priority Data
Aug. 2, 2010 (KR) 10-2010-0074721

(51) Int. Cl. F03D 9/00; F03D 11/00

(52) U.S. Cl. 290/55; 416/204 R

(57) ABSTRACT

The present invention relates to a variable windmill wing wind power generator having a power generation efficiency increasing means, which includes: an installation unit; a vertical rotating shaft; a bearing; ‘[’-shaped holders; a plurality of inner wing installation units; support rods; a plurality of outer wing installation units; support rings; vertical support rods; support bars; a plurality of diagonal support bars connected between the upper and lower outer wing installation units within the same group; ladders; windmill wings; support units; a power generating means; a windmill wing fixing means; and a fixing means driving device. According to the present invention, the wind power generator can fold the windmill wings in the wind receiving direction and unfold the windmill wings when they are rotated by 180° from the wind receiving direction so as to minimize a resistance force exerted on a rotary force of a windmill shaft, thus increasing the power generation efficiency. The wind power generator according to the present invention can simplify the manufacturing process by the simple structure and be installed in a plural number in various places regardless of the installation location, thus maximizing the amount of power generation per unit area, achieving the industrial purpose, and generating electricity in the environment-friendly fashion without causing pollution such as greenhouse gas. Also, the wind power generator according to the present invention can be installed in strong as a group with up/down multi-stages, stop easily the rotation operation of the windmill wings according to need, and reach easily a troubleshooter at the position of corresponding windmill wing which needs to repair, thus performing a follow-up control of maintenance conveniently.

### REFERENCE TO RELATED APPLICATIONS

This application is based on Korean Application No. 10-2010-0074721 filed on Aug. 2, 2010, the contents of which are hereby incorporated herein by reference.

### FIELD OF THE INVENTION

The present invention relates to a variable windmill wing wind power generator, and more particularly to, a variable windmill wing wind power generator having a power generation efficiency increasing means which can unfold the windmill wings in the wind receiving direction and unfold the windmill wings at 180° rotation direction from the wind receiving direction so as to minimize the air resistance applied to the windmill wings when rotating, thus increasing the power generation efficiency, and which can be easily installed in a plural number even in a narrow space regardless of the installation location, thus maximizing the amount of power generation per unit area and achieving the industrial purpose.

### BACKGROUND OF THE INVENTION

In general, the recent power generation methods include heat power generation using a large amount of fossil fuels, nuclear power generation using uranium, water power generation using a large-scaled desalination equipment, and so on. As such power generation methods are responsible for the air pollution or global warming, generate radioactive wastes difficult to dispose of, or cause huge environmental destruction, environment-friendly power generation methods demand immediate attention. Research has been actively made on solar power generation and wind power generation which are alternative environment-friendly methods. In particular, the wind power generation using the wind force has been most preferred. More attention needs to be paid to the wind power generation in Korea surrounded by the sea on three sides.

The wind power generation uses the force of wind and is a technique that a rotor is rotated using aerodynamic characteristics of kinetic energy due to floating of air and the kinetic energy is changed into mechanical energy, thus obtaining power. The wind power generator is classified with horizontal type and vertical type according to the direction of a rotation shaft to the ground and constructed by a rotator comprising wings and a hub, a speed increasing device for increasing the rotation of the rotor in order to drive a power generator, a control device for controlling the power generator and various safety devices, a hydraulic brake, a power controller, and a steel tower, as main components.

Also, the wind power generation almost never affect environment since it uses the pollution-free and unlimited wind which is scatted everywhere, can use effectively a country, and is a new energy generation technology with a level that can compete with the existing generation method in generation price in case of a large-scaled generation site.

A windmill in the wind power generator changes the kinetic energy rotated by wind into electric energy. At this time, in the windmill, about 60% of kinetic energy of the wind is changed into mechanical energy theoretically and then the mechanical energy is also changed into electric energy again, so that much energy is consumed in these processes. Accordingly, the change efficiency that wind energy is changed into electric energy has barely reached substantially about 20˜30%, although there are some differences to a great or small extent according to a shape of the windmill.

In the meantime, as described above, in the convention wind power generation, there is a problem that only when the wind is maintained over a constant speed and the air density is high, kinetic energy of the wind is delivered to wings and then the windmill is rotated, thereby changing the kinetic energy of the wind into electric energy. That is, if the wind is weak or when the gentle wind rises, the rotation of the windmill becomes weak, so the wind power generation is impossible.

Especially, in the conventional wind power generator, when wings of the windmill are rotated by 180 degrees from the wind receiving direction, the rotation of the windmill is blocked due to the resistance of wind or air and thus the power generation efficiency decreased.

In order to solve the foregoing problems, Korean Patent Publication No. 10-2009-56280 titled by “Windmill for wind power generator with variable type wings” has been disclosed in the Korean Patent Publication Gazette.

According to the Korean Patent Publication No. 10-2009-56280 titled by “Windmill for wind power generator with variable type wings”, as illustrated in FIG. 1, the windmill for wind power generator with variable type wings includes a case 110 coupled to a rotor rotating shaft of the power generator and then rotated together; wings 120 installed with a constant interval along circumferential longitudinal directions of the case 110 in order to be rotated the case 110 by wind, and folded and unfolded by the force of wind; a bracket 13 installed to the case 110 including the wings 120 rotatably installed through a hinge H and a driving member 130 for pivoting the wings 120 which are easily folded and unfolded according to the wind receiving direction; a cylinder 133 installed at the bracket 131 and having an operating space 133a formed at the inside thereof; a piston 135 built in the operating space 133a and moved by a linear motion; a tension spring 137 built in the operating space 133a in which the piston 135 is elastically supported to the direction of the wings 120; and a link 139 in which an end thereof is connected to the wings 120 and the other end thereof is connected to the piston 135, wherein when the front surface 121 of the wing 120 which has been unfolded is faced with the wind blowing direction by the rotation of the windmill, the wing 120 is unfolded, and when the rear surface 123 of the wing 120 is faced with the wind blowing direction, the wing 120 is pivoted and folded rapidly from the bracket 131 by the wind force and elasticity of the tension spring 127, so that the wind force transmitted to the wing 120 is lowered and so the rotation force of the windmill 100 is increased.

However, the Korean Patent Publication No. 10-2009-56280 titled by “Windmill for wind power generator with variable type wings” has several disadvantages: although the wings 120 are folded or unfolded by the blowing wind, the wings 120 are moved by 90 degrees and then folded and unfolded and this has caused the cases that the wings are not folded or unfolded well, as well as the increase of the power generation efficiency did not meet the expectations because an elastic force of the tension spring 137 for folding and unfolding the wings acts on as a force that blocks rotation of the windmill 100.

Also, the Korean Patent Publication No. 10-2009-56280 titled by “Windmill for wind power generator with variable type wings” has a disadvantage: it is difficult to perform a maintenance because it is not equipped with a means for repairing a breakdown separately. That is, when any one among plural wings does not work due to a breakdown, the windmill 100 is rotated by wind, so it is difficult to repair the broken wing after stopping the windmill 100.

Also, there is a problem: the conventional wind power generator performs the power generation by rotating a turbine regardless of the strength of wind and so although the wind is really strong, the amount of power generation cannot be increased.

Therefore, the present invention has been made to solve various shortcomings and problems associated with the conventional general wind power generator, and an object of the present invention is to provide a variable windmill wing wind power generator having a power generation efficiency increasing means which can operate by a gentle wind having a low velocity regardless of the direction of the wind and increase the number of turbines for performing power generation according to the strength of wind.

Another object of the present invention is to provide a variable windmill wing wind power generator having a power generation efficiency increasing means which can fold the windmill wings in the wind receiving direction and unfold the windmill wings when they are rotated by 180° from the wind receiving direction so as to minimize a resistance force exerted on a rotary force of a windmill shaft, thus increasing the power generation efficiency.

A further object of the present invention is to provide a variable windmill wing wind power generator having a power generation efficiency increasing means which can simplify the manufacturing process by the simple structure and be installed in a plural number in various places regardless of the installation location, thus maximizing the amount of power generation per unit area, achieving the industrial purpose, and generating electricity in the environment-friendly fashion without causing pollution such as greenhouse gas.

A further object of the present invention is to provide a variable windmill wing wind power generator having a power generation efficiency increasing means which can be installed in strong as a group with up/down multi-stages, stop easily the rotation operation of the windmill wings according to need, and reach easily a troubleshooter at the position of corresponding windmill wing which needs to repair, thus performing a follow-up control of maintenance conveniently.

### SUMMARY OF THE INVENTION

According to an aspect of the present invention for achieving the above objects of the present invention, there is provided a variable windmill wing wind power generator having a power generation increasing means, which includes: an installation mount stood on the floor in the shape of a cross and having a vertical rotating shaft holder in a central portion thereof; a vertical rotating shaft rotatably installed uprightly in the central portion of the installation mount; a bearing into which a top end of the vertical rotating shaft is rotatably inserted; holders connected and fixed between the bearing and the installation mount; a plurality of inner wing installation units fixedly installed on the vertical rotating shaft at given intervals in the up/down direction; support rods having one-side ends fixed to the inner wing installation units; a plurality of outer wing installation units to which outer ends of the support rods are fixed; support rings made of a steel wire and connected to the outer wing installation units on the same plane; vertical support rods made of a steel wire and connecting the outer wing installation units of the same group in the up/down direction, the upper and lower outer wing installation units being grouped in the up/down multi-stage fashion; a plurality of support bars made of a steel wire and connected between the highest support rod and the lowest support rod within the same group; a plurality of diagonal support bars connected and fixed between upper and lower outer wing installation units within the same group; a ladder fixed to the support rod of each stage; windmill wings installed between the inner wing installation units and the outer wing installation units in the up/down multi-stage fashion; support units installed on the vertical rotating shaft between the groups of the windmill wings made in the up/down multi-stage fashion, and connected to the holders through wires; windmill wing fixing means installed on the vertical rotating shaft above the inner wing installation units to be movable in the up/down direction and fixing displacements of the windmill wings; fixing means driving device installed on the bottom end side of the vertical rotating shaft; a power generation increasing means installed at the lower center portion of the installation mount so as to be changed the number of power generation turbines according to the strength of wind; and a plurality of power generation means installed on the bottom portion of the power generation increasing means and for performing power generation.

According to the present invention, the variable windmill wing wind power generator having a power generation increasing means can operate by a gentle wind having a low velocity regardless of the direction of the wind and drive a plurality of turbines according to the strength of wind, thus increasing the power generation efficiency. In addition, the variable windmill wing wind power generator having a power generation increasing means can fold the windmill wings in the wind receiving direction and unfold the windmill wings when they are rotated by 180° from the wind receiving direction so as to minimize a resistance force exerted on a rotary force of a windmill shaft, thus increasing the power generation efficiency. Moreover, the variable windmill wing wind power generator having a power generation increasing means can simplify the manufacturing process by the simple structure and be installed in a plural number in various places regardless of the installation location, thus maximizing the amount of power generation per unit area, achieving the industrial purpose, and generating electricity in the environment-friendly fashion without causing pollution such as greenhouse gas. Also, the variable windmill wing wind power generator having a power generation increasing means can be installed in strong as a group with up/down multi-stages, stop easily the rotation operation of the windmill wings according to need, and reach easily a troubleshooter at the position of corresponding windmill wing which needs to repair, thus performing a follow-up control of maintenance conveniently.

Hereinafter, a variable windmill wing wind power generator having a power generation increasing means according to preferred embodiments of the present invention will be described in detail with reference to the accompanying drawings.

### BRIEF DESCRIPTION OF THE DRAWINGS

FIG. 1 is a perspective view illustrating a construction of a windmill for a conventional wind power generator having variable wings;

FIG. 2 is a cross-sectional view illustrating a construction of wings and a driving member installed at a windmill for a conventional wind power generator having variable wings;

FIG. 3 is a perspective view of a variable windmill wing wind power generator having a power generation efficiency increasing means according to the present invention;

FIG. 4a is a perspective view illustrating an installation state of the windmill wings according to the present invention which are rotated in the clockwise direction;

FIG. 4b is a perspective view illustrating an installation state of the windmill wings according to the present invention which are rotated in the counterclockwise direction;

FIG. 5 is a view illustrating a construction of a support bar connected and installed in the same plane within the same group according to the present invention;

FIG. 6 is an exploded view of major parts of a variable windmill wing wind power generator having a power generation efficiency increasing means according to the present invention;

FIG. 7a is a perspective view of an inner wing installation unit and a moving unit according to another embodiment of the present invention;

FIG. 7b is a view of a multi-stage arrangement state of inner wing installation units and moving units in each group of the windmill wings according to the present invention;

FIG. 8 is a perspective view of a power generation efficiency increasing means according to the present invention;

FIGS. 9a to 9c are plan views illustrating a gear arrangement state of a power generation efficiency increasing means according to the present invention;

FIGS. 10a and 10b are views explaining an operation of a power generation efficiency increasing means according to the present invention;

FIG. 11a is a view illustrating energy efficiency and energy loss rate of a variable windmill wing wind power generator having a power generation efficiency increasing means according to the present invention;

FIG. 11b is a view illustrating a degree of energy efficiency of a variable windmill wing wind power generator having a power generation efficiency increasing means according to the present invention;

FIG. 12 is an explanatory view of the relation of interaction in the rotation efficiency between upper and lower groups;

FIG. 13a is a view illustrating power generation efficiency according to the wind speed of a conventional wind power generator;

FIG. 13b is a view illustrating power generation efficiency of a variable windmill wing wind power generator having a power generation efficiency increasing means according to the present invention;

FIG. 14a is a view illustrating a fixing means driving device according to the present invention, when the windmill wings rotate;

FIG. 14b is a view illustrating the fixing means driving device according to the present invention, when the rotation of the windmill wings is stopped;

FIG. 15 is a perspective view of a fixing means driving device according to the present invention;

FIG. 16 is a bottom view of a fixing means driving device according to the present invention;

FIG. 17a is an explanatory view of an operating state of the windmill wing fixing means according to the present invention, when the windmill wings rotate;

FIG. 17b is an explanatory view of an operating state of the windmill wing fixing means according to the present invention, when the rotation of the windmill wings is stopped;

FIG. 18a is a view of an operating state of the windmill wing fixing means according to the present invention, when the windmill wings rotate;

FIG. 18b is a view of an operating state of the windmill wing fixing means according to the present invention, when the rotation of the windmill wings is stopped;

FIG. 19a is a view of a state of the windmill wings displaced by the operation of the windmill wing fixing means according to the present invention, when the windmill wings rotate;

FIG. 19b is a view of a state of the windmill wings displaced by the operation of the windmill wing fixing means according to the present invention, when the rotation of the windmill wings is stopped; and

FIG. 20 is a schematic plan view of the flow of the wind between the windmill wings, when the variable windmill wing power generator having a power generation efficiency increasing means according to the present invention is installed in a plural number.

FIG. 21 is a comparative view of the installation state of the windmill wings between the conventional wind power generator and the wind power generator according to the present invention; and

FIG. 22 is a comparative view of the use efficiency of the installation land between the conventional wind power generator and the wind power generator according to the present invention.

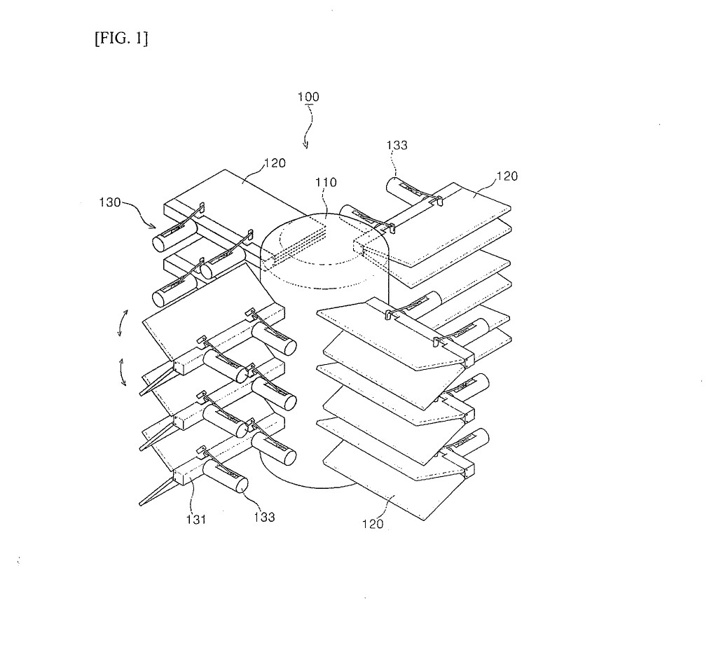

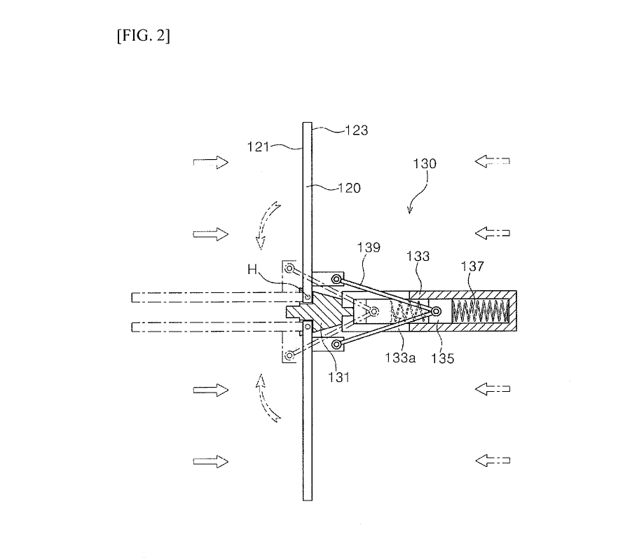

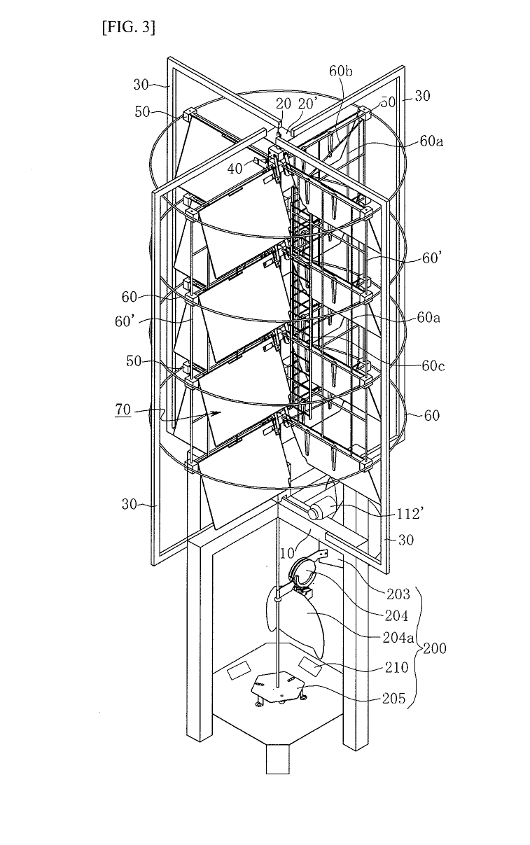

### DETAILED DESCRIPTION OF THE INVENTION

A variable windmill wing wind power generator A having a power generation increasing means according to the present invention includes: an installation mount 10 stood on the floor in the shape of a cross (+) and having a vertical rotating shaft holder in a central portion thereof; a vertical rotating shaft 20 rotatably and uprightly installed in the central portion of the installation mount 10; a bearing 20′ into which a top end of the vertical rotating shaft 20 is rotatably inserted; ‘[’-shaped holders 30 connected and fixed between the bearing 20′ and the installation mount 10; a plurality of inner wing installation units 40 fixedly installed on the vertical rotating shaft 20 at given intervals in the up/down direction; support rods 40′ having one-side ends fixed to the inner wing installation units 40; a plurality of outer wing installation units 50 to which outer ends of the support rods 40′ are fixed; support rings 60 made of a steel wire and connected to the outer wing installation units 50 on the same plane; vertical support rods 60′ made of a steel wire and connecting the outer wing installation units 50 of the same group in the up/down direction, the upper and lower outer wing installation units 50 being grouped in the up/down multi-stage fashion; a plurality of support bars 60a made of a steel wire and connected between the highest support rod 40′ and the lowest support rod 40′ within the same group; a plurality of diagonal support bars 60b connected and fixed between upper and lower outer wing installation units 50 and 40 within the same group; a ladder 60c′ fixed to the support rod 40′ of each stage; windmill wings 70 installed between the inner wing installation units 40 and the outer wing installation units 50 in the up/down multi-stage fashion; support units 80 installed on the vertical rotating shaft 20 between the groups of the windmill wings 70 made in the up/down multi-stage fashion, and connected to the ‘[’-shaped holders 30 through wires 81; windmill wing fixing means 90′ installed on the vertical rotating shaft 20 above the inner wing installation units 40 to be movable in the up/down direction and fixing displacements of the windmill wings 70; fixing means driving device 100′ installed on the bottom end side of the vertical rotating shaft 20; a power generation increasing means 200 installed at the lower center portion of the installation mount 10 so as to be changed the number of power generation turbines according to the strength of wind; and a plurality of power generation means 300 installed on the bottom portion of the power generation increasing means 200 and for performing power generation.

Each of the inner wing installation units 40 is divided into an installation unit 40a and an installation unit 40b, which are coupled to each other by a bolt 41, the ends of the support rods 40′ are inserted into the inner wing installation unit 40 in the horizontal direction from the front, rear, left and right directions and fixed thereto by a bolt 42 downwardly inserted from the top surface, the ends of wing rotating shafts 71 are rotatably inserted into the inner wing installation units 40 on the same plane as the support rods 40′, the ends of rotating shafts 96 of the windmill wing fixing means 90′ are rotatably inserted into the inner wing installation units 40 below the inserted portions of the support rods 40′ and the wing rotating shafts 71, the other ends of the support rods 40′ are inserted into and fixed to the outer wing installation units 50, and the respective other ends of the wing rotating shafts 71 and the rotating shafts 96 are rotatably inserted into the outer wing installation units 50.

Each of the windmill wings 70 includes a wing rotating shaft 71 rotatably installed between the inner wing installation unit 40 and the outer wing installation unit 50 on the same plane as the support rod 40′, a wing part 72 having one side fixed to the wing rotating shaft 71, and a wing spring 73 inserted into a central portion of the wing rotating shaft 71 and maintaining the wing part 72 at 45° from the horizontal surface during non-operation.

Here, the wing parts 72 are preferably made of a material having a light weight and a high density, and thus made of any one selected from the group consisting of transparent or opaque reinforced plastic, strengthened glass, non-ferrous metal, and duralumin.

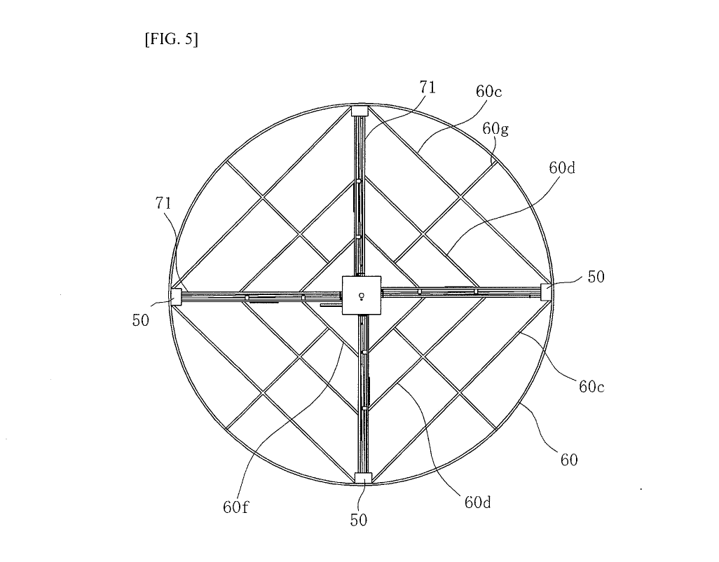

As shown in FIG. 5, the wing rotating shafts 71 located on the same plane within the same group are connected with plural steel wire support bars 60c, 60d and 60f, and plural steel wire support bars 60c are connected and fixed between the support ring 60. Also, the support bar 60c and the support bar 60d, and the support bar 60f and the support ring 60 are connected with each other by support bars 60g.

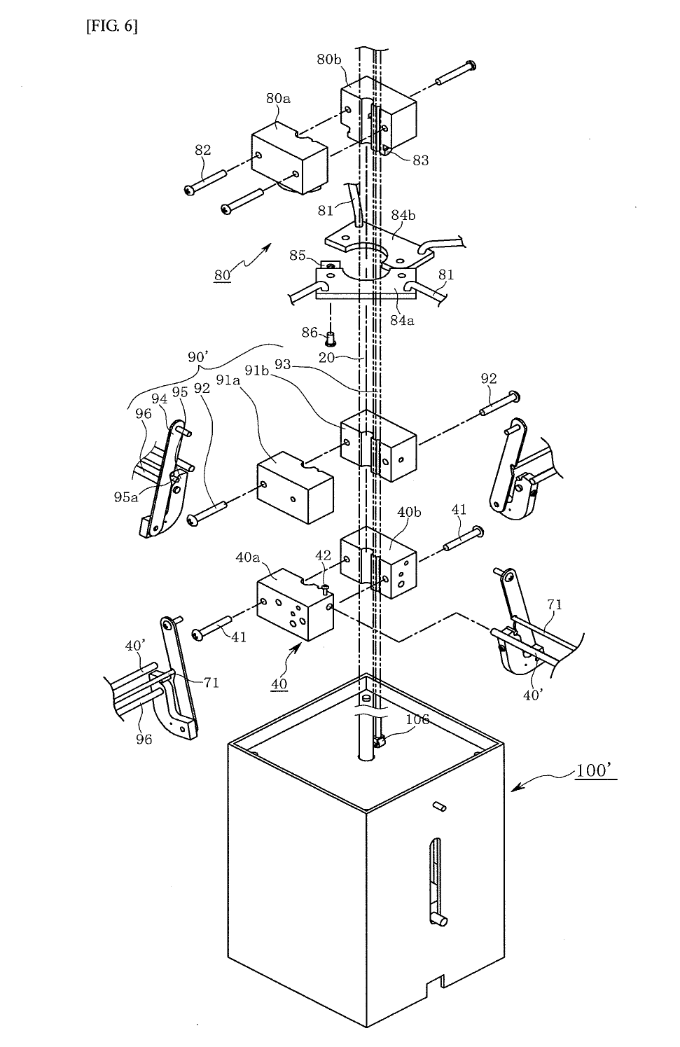

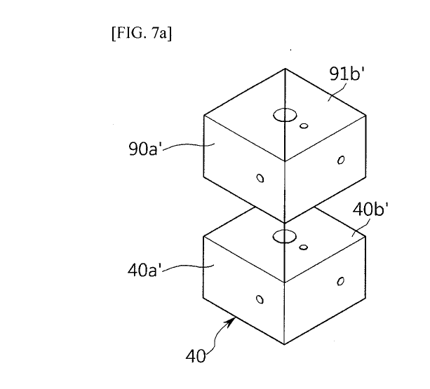

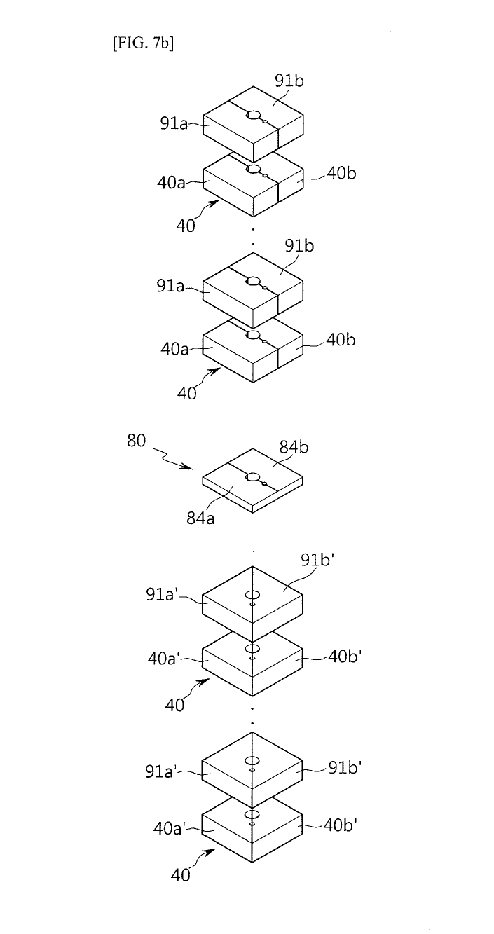

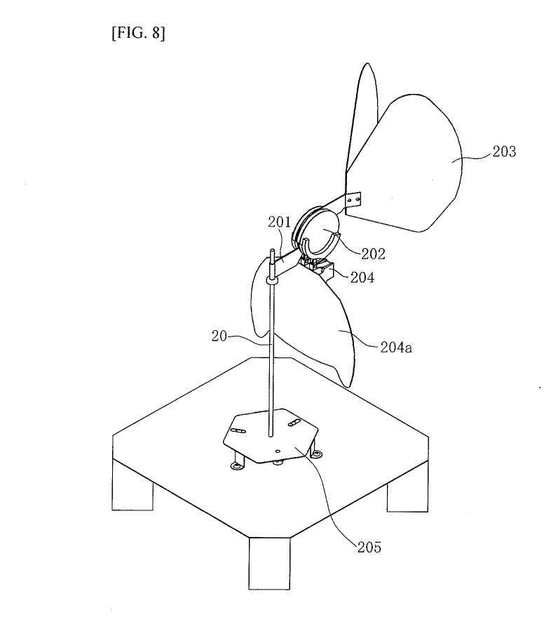

The inner wing installation units 40 are divided into a structure in which the cutting side of the central portion for dividing the installation unit 40 into the installation unit 40a and the installation unit 40b is parallel to the outer side as shown in FIG. 6 and a structure in which the cutting side for dividing the installation unit 40 into the installation unit 40a′ and the installation unit 40b′ is diagonal as shown in FIG. 7a. In addition, the moving units are divided into a structure in which the cutting side of the central portion for dividing the moving unit into the moving unit 91a and the moving unit 91b is parallel to the outer side as shown in FIG. 6 and a structure in which the cutting side for dividing the moving unit into the moving unit 91a′ and the moving unit 91b′ is diagonal as shown in FIG. 7a. Referring to FIG. 7b, the installation units and the moving units are alternately installed so that the groups located over the support units 80 can be the groups in which the cutting surfaces are parallel to the outer side and the groups located below the support units 80 can be the groups in which the cutting surfaces are diagonal (or so that the groups located over the support units 80 can be the groups in which the cutting surfaces are diagonal and the groups located below the support units 80 can be the groups in which the cutting surfaces are parallel to the outer side). Therefore, the wing part 72 of one group which corresponds to the wing part 72 receiving the wind in the vertical direction among the wing parts 72 of the windmill wings 70 of the other group is more or less rotated than the wing part 72 receiving the wind in the vertical direction by 45°. In each group, whenever the wing rotating shafts 71 of the windmill wings 70 are rotated by 90°, the wing parts 72 receive the wind in the vertical direction. However, in terms of the entire groups, whenever the wing rotating shafts 71 are rotated by 45°, the wing parts 72 of the groups alternately receive the wind in the vertical direction.

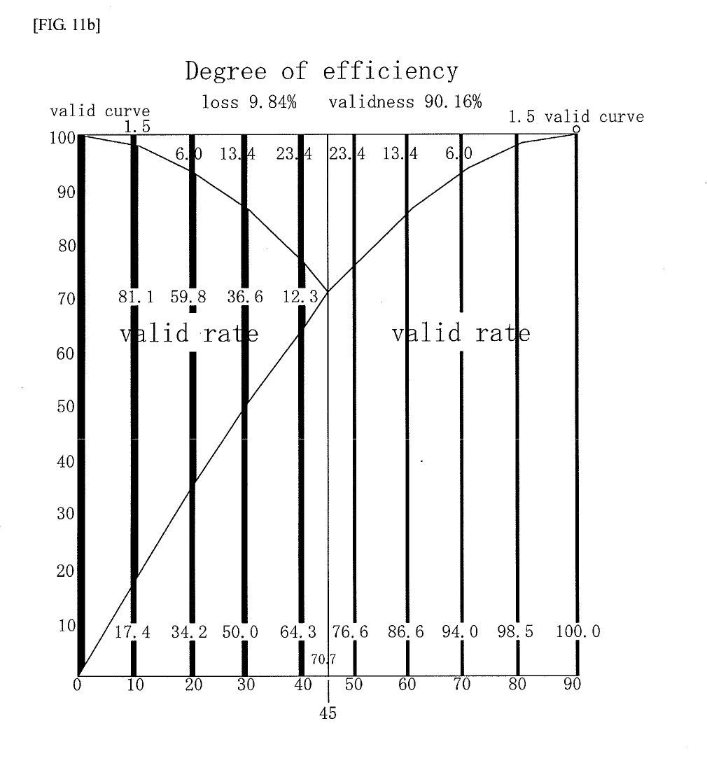

That is, as shown in FIG. 11a, if the wing parts 72 of a first group receive the wind in the vertical direction and the strength of wind is 100, when a wing part 72 is rotated by 10° and then located at the position of (a), the subsequent wing part 72 is located at the position of (b). Therefore, the wing part 72 located at the position of (a) receive the strength of wind corresponding to the value obtained by deducting the value that the wind is blocked by the wing part 72 located at the position of (b) from the value given as cosine x (x is an angle). Also, the wing part 72 located at the position of (b) receive the strength of wind corresponding to the value given as sine x (x is an angle).

Accordingly, the strength of wind which the wing part 72 located at the position of (b) receives is 17.4 as sine 10° and the strength of wind which the wing part 72 located at the position of (a) receives is 98.5−17.4=81.1 as cosine 10°-17.4, so the sum of energy of two wing parts is 98.5 and thus the energy loss rate is 1.5 (that is, 100-98.5). Like this, the entire energy efficiency and energy loss rate according to the rotation of wing parts 72 of each group are shown in FIG. 11a and the energy efficiency degree is shown in FIG. 11b, thus the power generation efficiency is enhanced.

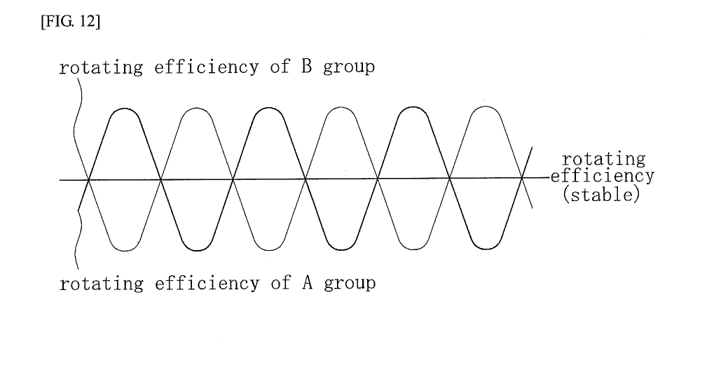

Also, when the strength of the wind which a wing part 72 in one group (A group) receives become maximum, the strength of the wind which a wing part 72 in the other group (A group) receives become minimum, and therefore, the rotation efficiency of the vertical rotary shaft 20 by the wing part 72 of A group and the rotation efficiency of the vertical rotary shaft 20 by the wing part 72 of B group are offset, as shown in FIG. 12, and thus a constant stable rotation efficiency can be obtained.

Moreover, each of the support units 80 is divided into a support body 80a and a support body 80b, which are coupled to each other by a bolt 82, support plates are inserted into bottom circular projection portions 83 formed by the coupling of the support body 80a and the support body 80b, each of the support plates is divided into a support plate 84a and a support plate 84b so that one support plate forms a hinge structure and the other support plate is coupled to a bolt 86 through the medium of a bracket 85, the ends of the wires 81 are fixed to four edges of the coupled support plates 84a and 84b, and the other ends of the wires 81 are connected and fixed to the ‘[’-shaped holders 30.

Here, the support bars 60c, 60d, 60f, 60g, and 60a, diagonal support bars 60b, outer wing installation units 50, support rings 60, wing rotary shafts 71, support bars 60h, and inner wing installation units 40 have the dimension as the following table 1, preferably.

TABLE 1
Dimension of components of wind power generator

| Reference | | | | | | | |
|---|---|---|---|---|---|---|---|
| numerals | | | | | | | Total |
| of | Length | num- | ra- | Circular | Specific | Weight | length |
| drawing | (cm) | ber | dius | constant | gravity | (kg) | (cm) |
| 60c | 630 | 4 | 1² | 3.14 | 7.85 | 62.11 | 2520 |
| 60d | 420 | 4 | 1² | 3.14 | 7.85 | 41.41 | 1680 |
| 60f | 210 | 4 | 1² | 3.14 | 7.85 | 20.70 | 840 |
| 60g | 340 | 4 | 1² | 3.14 | 7.85 | 33.52 | 1360 |
| 60a | 310 | 12 | 1² | 3.14 | 7.85 | 91.69 | 3720 |
| 60b | 550 | 4 | 1² | 3.14 | 7.85 | 54.22 | 2200 |
| 50 | 450 | 4 | 1.5² | 3.14 | 7.85 | 99.82 | 1800 |
| 60 | 2826 | 4 | 1.5² | 3.14 | 7.85 | 156.73 | 2826 |
| 71 | 450 | 8 | 1² | 3.14 | 7.85 | 85.68 | 3600 |
| 60h | 1,000 | 4 | 0.5² | 3.14 | 7.85 | 24.69 | 4000 |
| 40 | 310 | 1 | 4² | 3.14 | 7.85 | 122.25 | 310 |

As shown in the table 1, the support bodies, as various installation materials, including a plurality of support bars 60a for supporting the wind power generator A, a plurality of diagonal support bars 60b, support bars 60c,60d,60f,60g, and 60h, and support rings 60 can be made to have a light weight and the reason is as follows.

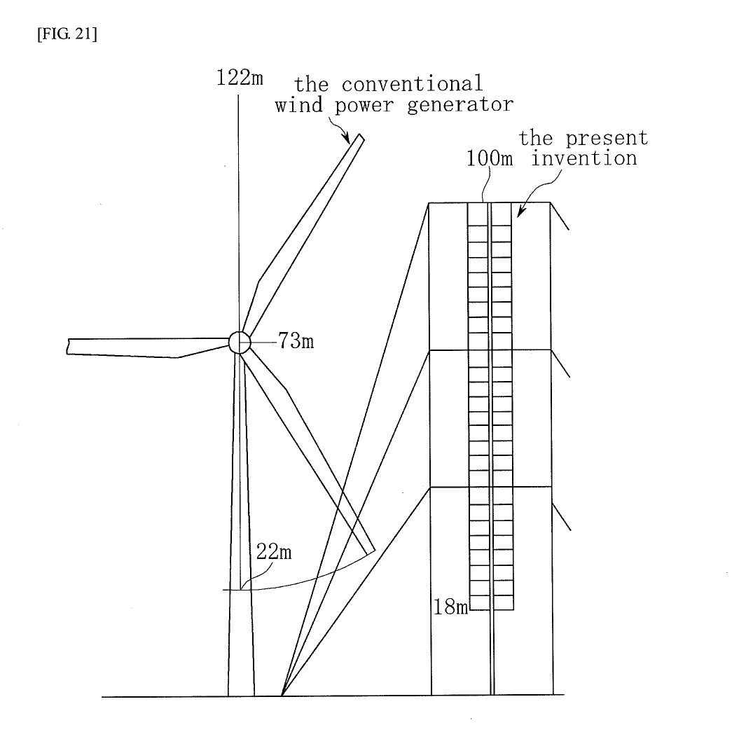

That is, as shown in FIG. 21, according to the conventional wind power generator, the windmill wings with heavy weight are fixed only at the center portion and thus an enormous force is acted by the principle of leverage of the windmill wings at the connection portion of the windmill wings. Therefore, a specific connection construction is required: a connection area of the connection portion must be increased especially. According to the present invention, the center of gravity of the windmill wings in the wind power generator A is spread and thus the supporting force of the windmill wings 70 is spread to a plurality of support bodies such as a plurality of support bars 60a, a plurality of diagonal support bars 60b, support bars 60c, 60d, 60f, 60g, and 60h, and support rings 60c and so on. Accordingly, the installation materials including the respective supporting bodies can be made to have a light weight and so the cost of materials can be reduced.

Together with the spreading of the support force, the supporting bodies are constructed by a circular plane type, as shown in FIG. 5. According to the present invention, the windmill wings 70 located at a group of the wind power generator A (for example, the windmill wings of A group) are installed and then the windmill wings of B group can be easily installed on the windmill wings 70 of A group like an assembly type by using the circular plane of FIG. 5 formed by support bodies of A group as a foothold. Accordingly, a tower crane required at the conventional installation work is unnecessary and thus the required installation cost can be reduced drastically.

Each of the windmill wing fixing means 90′ is divided into the moving unit 91a and the moving unit 91b, which are coupled to each other by a bolt 92 so that the moving unit 91a and the moving unit 91b can move in the up/down direction with the vertical rotating shaft 20 inserted into a central portion thereof, a moving shaft 93 for moving the moving unit 91a and the moving unit 91b in the up/down direction is inserted and fixed between the moving unit 91a and the moving unit 91b, the ends of the straight lever 94 are fixed to outer surfaces of the coupled moving units 91a and 91b, respectively, the ends of ‘L’-shaped levers 95 are rotatably connected to the other ends of the straight levers 94, rotating shafts 96 provided with springs 96a are inserted into the other ends of the ‘L’-shaped levers 95 and rotatably inserted into the inner wing installation units 40, stopper pins 95a for stopping rotation of the ‘L’-shaped levers 95 are inserted into and fixed to the inner wing installation units 40 on which the other ends of the ‘L’-shaped levers 95 are located, the springs 95a have the ends mounted on and fixed to the support rods 40′ and the other ends fixed on the ‘L’-shaped levers adjacent to the connection portions of the straight levers 94 and the ‘L’-shaped levers 95, and a plurality of levers 97 are fixed on the rotating shafts 96 at given intervals.

Also, the fixing means driving device 100′ includes: a rectangular box body 101′; a lower fixing plate 102′ fixed to a lower portion in the rectangular box body 101′; a pair of rollers 103′ installed at a lower side of the lower fixing plate 102′; lower rollers 104′ installed at every lower side corner of the lower fixing plate 102′; a lower moving plate 105′ moved upwardly and downwardly in the rectangular box body 101′; a spring 106′ inserted into the upper side center of the lower moving plate 105′; a plurality of moving shafts 107′ fixed uprightly at the corner of the lower moving plate 105′; an upper fixing plate 108′ fixed to an upper portion in the rectangular box body 101′; upper rollers 109′ installed at every lower side corner of the upper fixing plate 108′; an upper moving plate 110′ fixed at an upper end of a plurality of moving shafts 107′; a rope means 111′ comprising ropes 111a˜111d which is hung the rollers 103′ and upper and lower rollers 109′ and 104′; and a motor 112′ for winding and unwinding the rope means 111′.

The rectangular box body 101′ includes a guide groove 101a, which has oblong shapes at upper and lower portions thereof, formed at a side of the rectangular body. The lower fixing plate 102′ is fixed to a lower portion of the rectangular box body 101′ by a ‘┐’-shaped bracket al. The rollers 103′ and 104′ are fixed to a lower side of the lower fixing plate 102′ by a bracket b. The lower end of the moving shaft 107′ is fixed to the corner of the lower moving plate 105′ by nuts c and c′ and the upper end of the moving shaft 107′ is fixed to the upper moving plate 110′ by nuts c and c′. A guide member 105a having a guide protrusion d is fixed at an upper side end of the lower moving plate 105′ and the guide protrusion d is inserted into the guide groove 101a. A fixing bolt e is formed at a side of the upper fixing plate 108′ and inserted and fixed into a side of the rectangular box body 101′, and an upper roller 109′ is fixed to a lower side of the upper fixing plate 108′ by a bracket b.

Also, the power generation efficiency increasing means 200 includes: a circular plate shape switch driving means 202 installed at a support shaft, which installed uprightly and separately adjacent to the vertical rotating shaft 20, by a bracket 201; a rudder 203 connected and installed to the switch driving means 202, wherein it is rotated according to the wind blowing direction to receive the wind direction frontally; a switch 204 having a wind receiving wing 204a which is installed at a lower portion of the switch driving means 202 and turned on or off according to the strength of wind; a driving gear 206 connected with a lower end of the vertical rotating shaft 20 within a housing 205 equipped to a lower end portion of the vertical rotating shaft 20; a first driven gear 207 engaged with the driving gear 206; a second and a third driven gears 208 and 209 installed adjacent to the driving gear 206 and engaged with the driving gear 206 according to the strength of wind; and an air compressor 210 for pushing all or any one among the first to the third driven gears 207,208, and 209 to the driving gear 206 through the respective linear actuators according to the contact point state of the switch so as to be engaged with the driving gear 206.

The switch 204 includes a wind receiving wing 204a, a right side contact roller 204b contacted to the right outer circumferential edge of the switch driving means 202, and a left side contact roller 204b′ contacted to the left outer circumferential edge of the switch driving means 202. When the strength of wind becomes the constant strength, the right outer circumferential edge of the switch driving means 202 pushes the right contact roller 204b and is switched. When the strength of wind becomes stronger, the left outer circumferential edge of the switch driving means 202 pushes the left contact roller 204b′ and is switched. That is, the left and right outer circumferential edges of the switch driving means 202 are protruded with a constant angle and thus the protrusions push the left and right contact rollers 204b′ and 204b downwardly so that the switching of the switch 204 is performed.

Also, the power generation means 300 includes power generators 301,302, and 303 installed at the lower portions of the first to third driven gears 207, 208, and 209 engaged with the driving gear 206, respectively.

The reason for dividing the support unit 80 into the support body 80a and the support body 80b, the support plate into the support plate 84a and the support plate 84b, the windmill wing fixing means 90′ into the moving unit 91a and the moving unit 91b or the moving unit 91a′ and the moving unit 91b′, and the inner wing installation unit 40 into the installation unit 40a and the installation unit 40b or the installation unit 40a′ and the installation unit 40b′ is because a corresponding broken part can be easily replaced and repaired in the event of a failure.

Here, preferably, so as to increase the generated power, the windmill wings 70 are installed in the up/down n-stage, the wind power generator A having the up/down n-stage windmill wings 70 is installed in a plural number in the front/rear and left/right horizontal directions, and the power generation means 90 of the respective wind power generations A are electrically connected with each other, so that power generated by each power generation means 90 is combined.

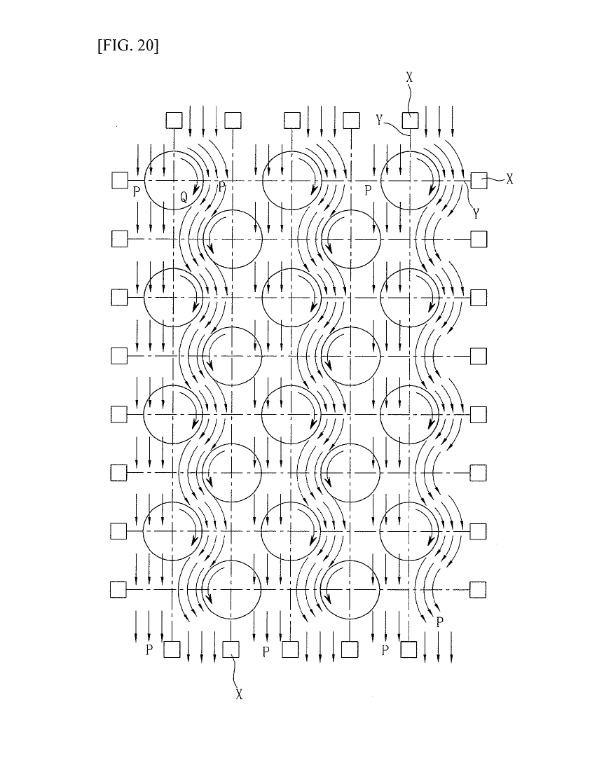

In addition, when the plurality of wind power generators A having the up/down n-stage windmill wings 70 are installed in the front/rear and left/right horizontal directions, as illustrated in FIG. 20, although a plurality of pillars X are vertically installed on front/rear and left/right outer portions, and connected and fixed to the bearing portions 20′ of the respective wind power generators A by wires Y, the wind power generators A do not hide the sunlight. Accordingly, the wind power generator A can be installed on a building, farmland, forest land, or marine farm, and thus is not limited in the installation location.

Next, the operation of the variable windmill wing wind power generator having the power generation efficiency increasing means with the above-described construction according to the present invention will be described in detail.

In the wind power generator A according to the present invention, the windmill wings 70 opposite to the wind blowing direction are pushed by the blowing wind, so that the wing parts 72 are suspended on the levers 97, receive the wind in the vertical state, and thus push the support rods 40′. Therefore, the wing parts 72 receiving the wind rotate the vertical rotating shaft 20 through the wing rotating shafts 71, thereby generating power.

Here, as the wing parts 72 rotated upon the rotation of the vertical rotating shaft 20 by 90° from the vertical surface orthogonal to the direction of the wind rotated again, the wing parts 72 are lifted to the horizontal state due to the resistance force of the air, and thus do not receive the resistance of the air. As the vertical rotating shaft 20 rotates, the wing parts 72 rotate again. The wing parts 72 rotated by 270° from the vertical surface orthogonal to the direction of the wind rotate again, and thus maintain 45° from a horizontal surface by the wing spring 73. In this situation, if the wing parts 72 rotate again, they are pushed again by the blowing wind, suspended on the levers 97, receive the wind in the vertical state, and push the wing rotating shafts 71, so that the vertical rotating shaft 20 is continuously rotated to generate power.

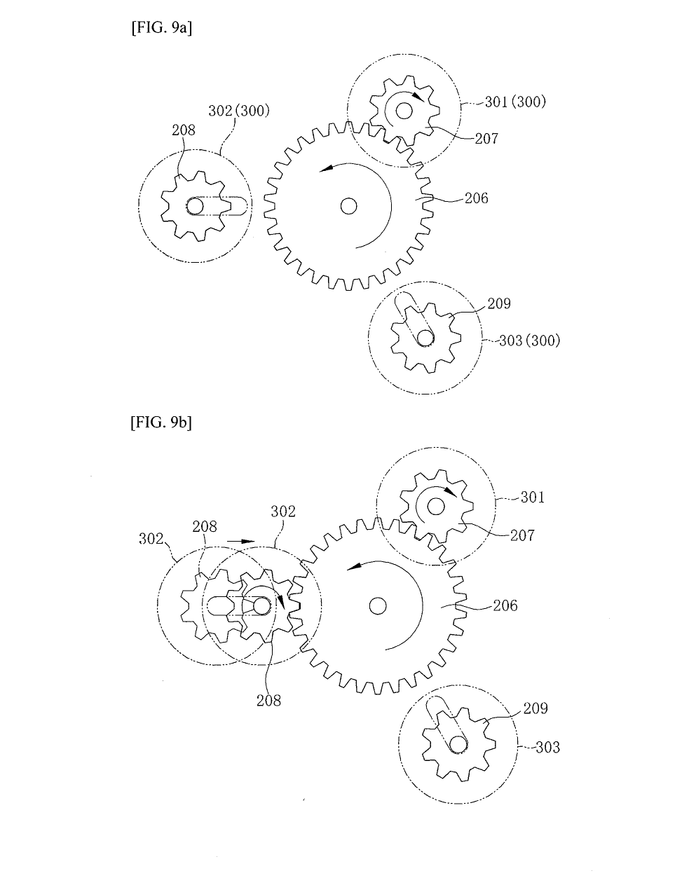

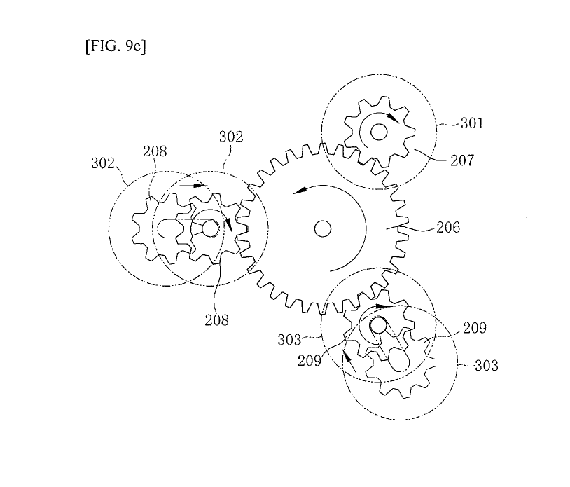

Also, as the strength of wind increases, so does the number of generators. When the strength of wind is constant, as shown in FIG. 9a, the first driven gear 207 is engaged with the driving gear 206 connected with the vertical rotating shaft 20 and so the generator 301 connected at the lower portion of the first driven gear 207 is generated by rotating the vertical rotating shaft 20.

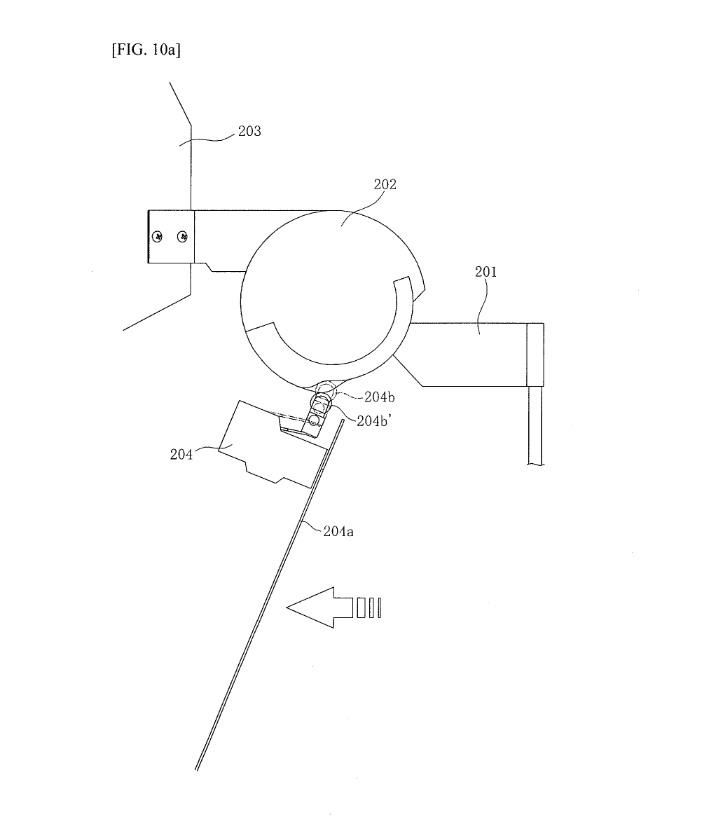

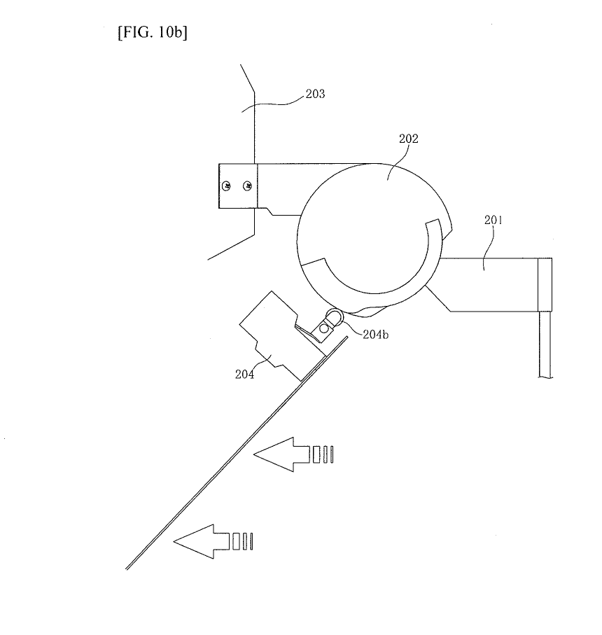

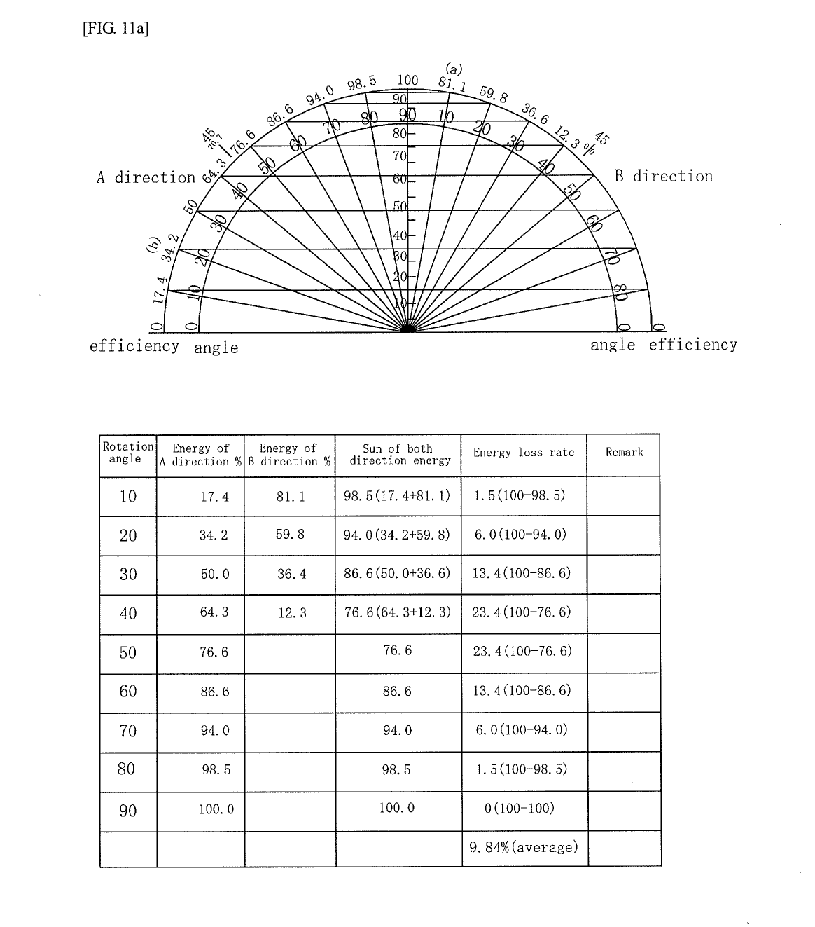

In the state that the generator 301 is only generated, when the wind exceeds a constant speed per second, as shown in FIG. 10a, a wind receiving wing 204a is pushed to the rear, so left and right contact rollers 204b′ and 204b are pushed to the rear together with a switch 203. Thus, firstly, the right side contact roller 204b is pushed downwardly by the right circumferential surface edge of the switch driving means 202 and so a switch contact point is connected by the right side contact roller 204b. An air compressor 208 is operated by the switch connection and so a linear actuator is operated and the second driven gear 208 is pushed to the driving gear 206. As a result, the driving gear 206 and the second driven gear 208 are engaged with each other. Accordingly, as shown in FIG. 9b, the first and second driven gears 207 and 208 are simultaneously engaged with the driving gear 206 and so two power generators 301 and 302 are simultaneously generated.

When the strength of wind become stronger, as shown in FIG. 10b, a wind receiving wing 204a is pushed more to the rear, so left and right contact rollers 204b′ and 204b are pushed to the rear together with a switch 203. Thus, the left side contact roller 204b′ is pushed downwardly by the left circumferential surface edge of the switch driving means 202 and so a switch contact point is connected by the left side contact roller 204b′. At this time, two switch contact points are connected all by the left and right side contact rollers 204b′ and 204b. Thus, an air compressor 208 is operated by the connection of two switches and so a linear actuator is operated and the third driven gear 209 together with the second driven gear 208 is pushed to the driving gear 206. Accordingly, as shown in FIG. 9c, the first, second, and third driven gears 207, 208, and 209 are simultaneously engaged with the driving gear 206 and so three power generators 301, 302, and 303 are simultaneously generated.

Here, although only the first, second and third driven gears 207, 208, and 209 are installed and explained, the driven gear can be installed above three.

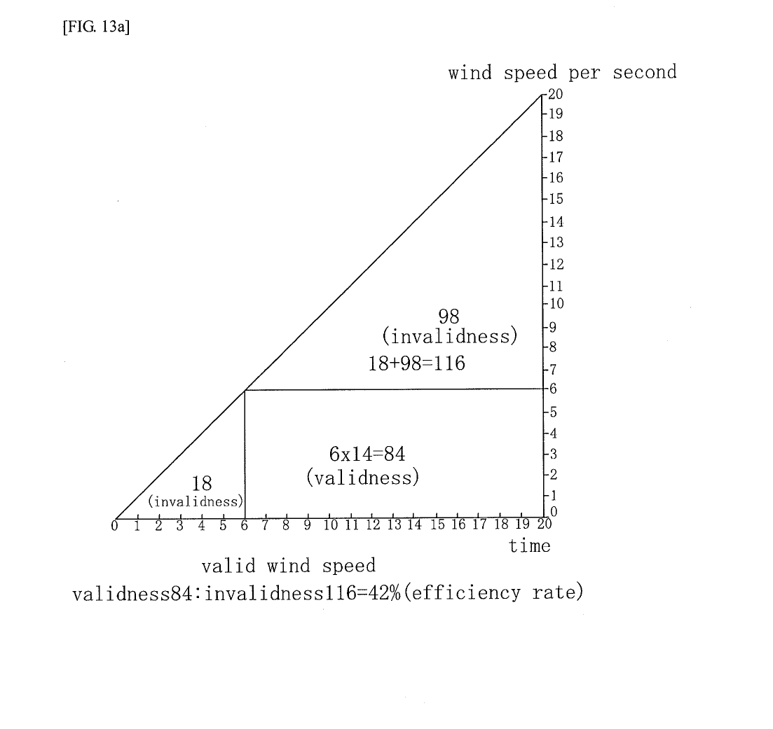

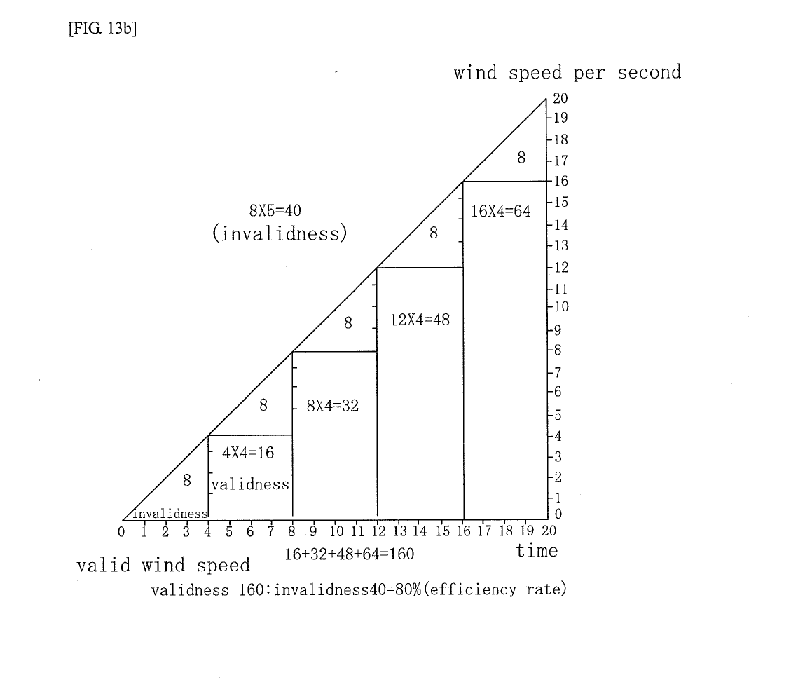

FIG. 13a is a view illustrating power generation efficiency according to the wind speed of a conventional wind power generator. FIG. 13b is a view illustrating power generation efficiency of a variable windmill wing wind power generator having a power generation efficiency increasing means according to the present invention.

As shown in FIG. 13a, according to a conventional invention, if the wind with 6 m/s for 14 hours rises, the valid wind for generating power is 84 by 6×14 and the invalid entire wind for generating power is 116 by 18+98, so that the efficiency rate is 42% by 84/200. Whereas, as shown in FIG. 13b, according to the present invention, it is assumed that the wind with 4 m/s for 4 hours rises, the wind with 8 m/s for 4 hours rises, the wind with 12 m/s for 4 hours rises, and the wind with 16 m/s for 4 hours rises. 1). If the wind with 4 m/s for 4 hours rises, the valid wind for operating one generator is 16 by 4×4. 2). If the wind with 8 m/s for 4 hours rises, the valid wind for operating two generators is 32 by 8×4. 3). If the wind with 12 m/s for 4 hours rises, the valid wind for operating three generators is 46 by 12×4. 4). If the wind with 16 m/s for 4 hours rises, the valid wind for operating four generators is 64 by 16×4. Accordingly, the valid entire wind for generating power is 160 by 16+32+48+64 and the invalid entire wind for generating power is 40 by 8×5, so that the efficiency rate is 80% by 160/200.

Also, since the wing parts 72 which form groups up and down are installed by the rotated state to the rotating direction with a constant angle, if the wing parts 72 of a group are rotated with a constant angle at the vertical surface to the wind direction, the wing parts 72 of another group form the same fashion, so that the wing parts 72 of each group form the vertical surface to the wind direction sequentially, thereby enhancing the power generation efficiency.

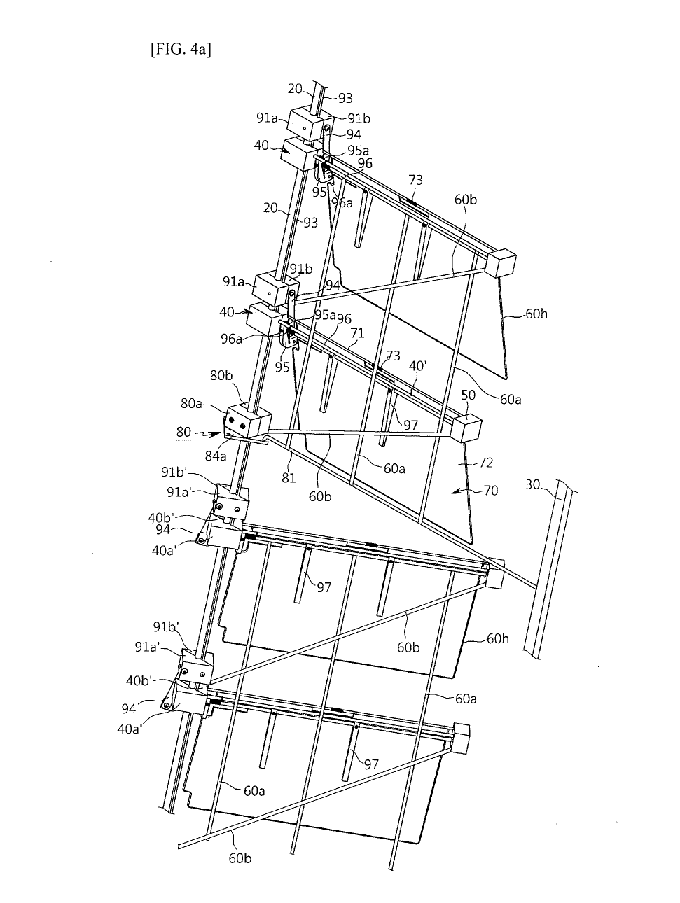

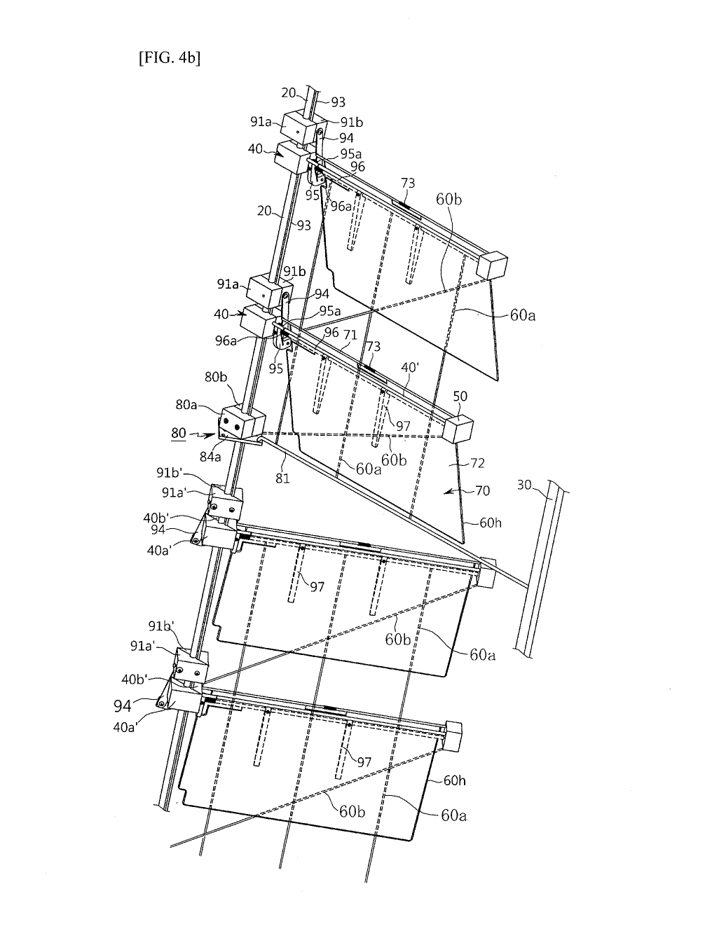

The operation of the windmill wings 70 described above can be accomplished in that the wing parts 72 receiving the wind are suspended on the levers 97 in the front/rear direction (see FIGS. 4a and 4b) and are horizontal with respect to the ground in the opposite side after 180° rotation.

FIG. 20 is a schematic plan view of the flow of the wind between the windmill wings, when the variable windmill wing power generator having a power generation efficiency increasing means according to the present invention is installed in a plural number.

As shown in FIG. 20, arrows P indicate the wind blowing directions and arrows Q indicate the rotation directions of the respective wind power generators A. The wind power generators A of the first column are rotated in the clockwise direction and the wind power generators A of the second column are rotated in the counterclockwise direction. In addition, the wind power generators A of the third column are rotated in the clockwise direction and the wind power generators A of the fourth column are rotated in the counterclockwise direction. In this way, the wind power generators A of the respective columns are alternately rotated in opposite directions.

Here, the wind blowing into a wide region gets stronger through narrow regions such as between the wind power generators A of the first column and the wind power generators A of the second column and between the wind power generators A of the third column and the wind power generators A of the fourth column, so that the power generation efficiency of the wind power generators A increases. In this case, even if the wind blows in the front/rear, left/right or diagonal direction, the wind power generators A make a pair by two columns, so that the wind power generators A of one column are rotated in the clockwise direction and the wind power generators A of the other column are rotated in the counterclockwise direction to generate power.

The rotation directions of the wind power generators A as described above can be accomplished in that each column selectively employs the structure in which the wing parts 72 are suspended on the front lever 97 in the rear (see FIG. 4a) and the structure in which the wing parts 72 are suspended on the rear levers 97 in the front (see FIG. 4b). That is, the wind power generators A having the windmill wings 70 as shown in FIG. 4a are rotated in the clockwise direction and the wind power generators A having the windmill wings 70 as shown in FIG. 4b are rotated in the counterclockwise direction.

FIG. 21 is a comparative view of the installation state of the windmill wings between the conventional wind power generator and the wind power generator according to the present invention.

As shown in FIG. 21, in the conventional invention, the windmill wings with the height of wing of 50 m are installed at the height between 22 m and 122 m from the ground, whereas, the present invention has three groups up and down, in each group, a plurality of wings are installed up and down and the wings are installed at the height between 18 m and 100 m from the ground.

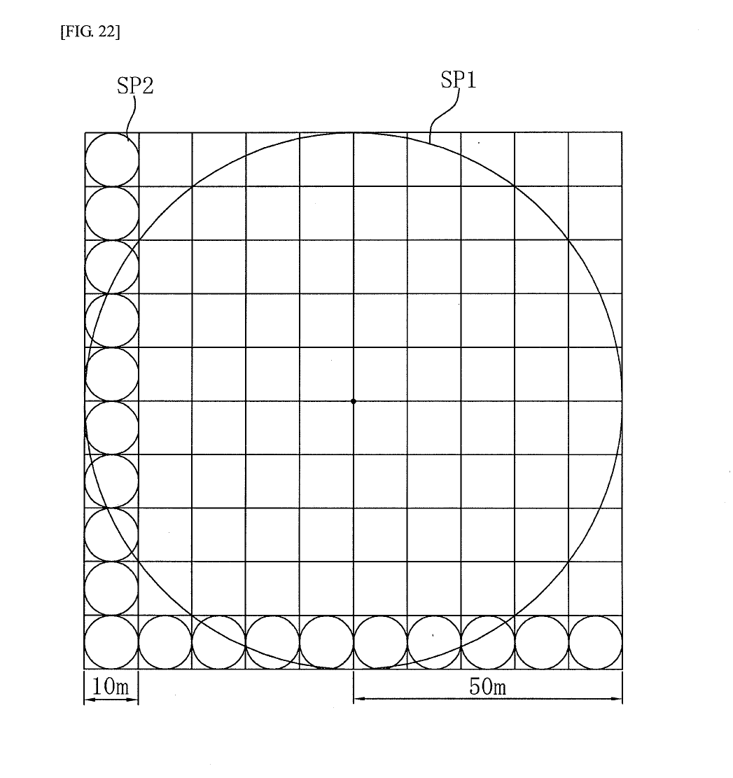

FIG. 22 is a comparative view of the use efficiency of the installation land between the conventional wind power generator and the wind power generator according to the present invention.

As shown in FIG. 22, the view is comparing an installation region SP1 of the power generator with the length of wing of 50 m according to the conventional invention with an installation region SP2 of the power generator with the length of wing of 5 m according to the present invention. The installation region SP1 of the power generator according to the conventional invention is 50²×π and the installation region SP2 of the power generator according to the present invention is 5²×π, so that the present invention can increase 100 times of the use efficiency of the installation land compared to the conventional invention.

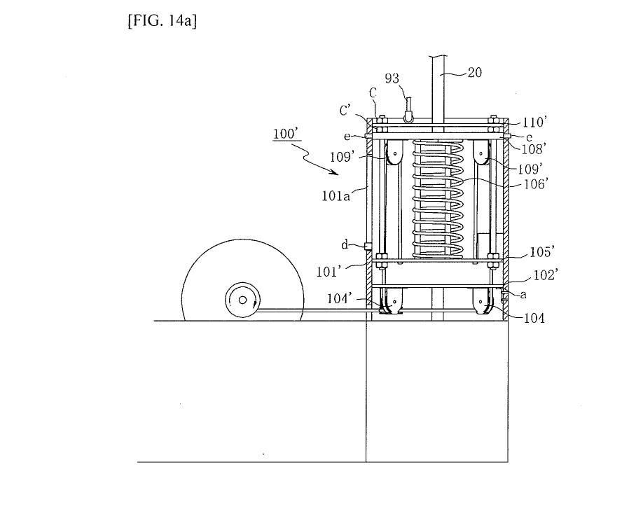

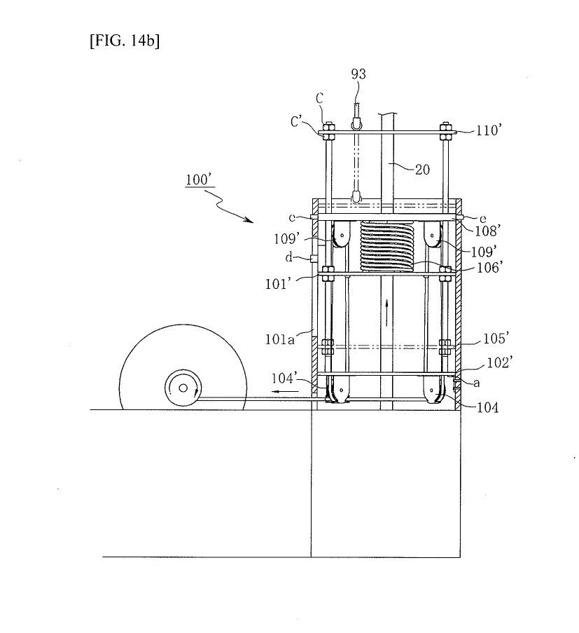

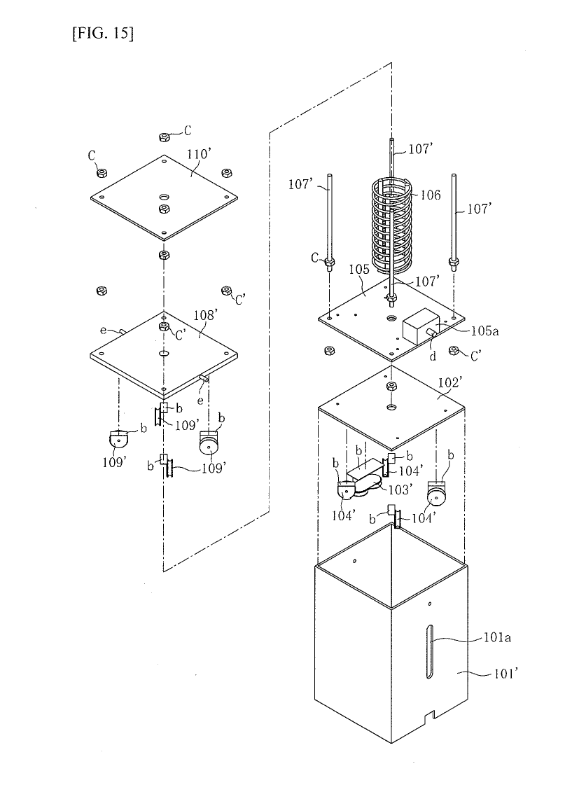

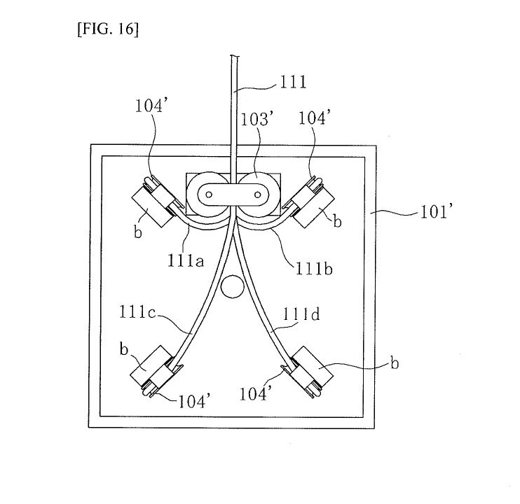

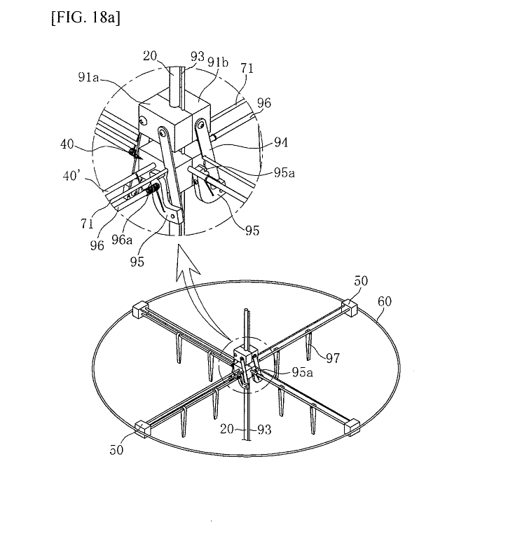

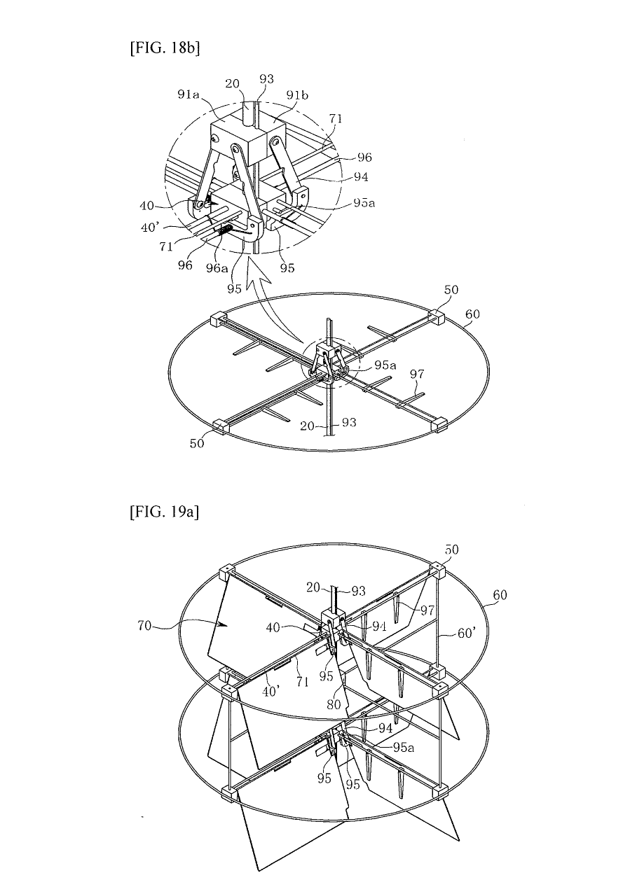

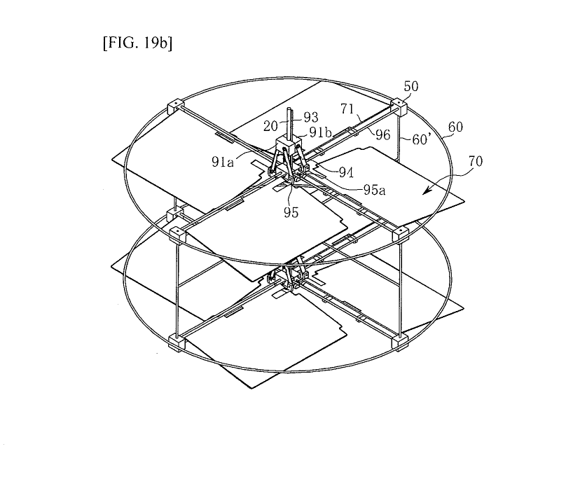

If the wind power generator A having the variable windmill according to the present invention which performs the wind power generation as described above, as illustrated in FIGS. 14a, 17a, 18a, 19a, in a state where the windmill wing fixing means 90′ do not operate, the lever 97 have a vertical downward state to maintain the windmill wings 70 receiving the wind to be in the vertical state, so that the windmill wings 70 operate in the normal state and generate power.

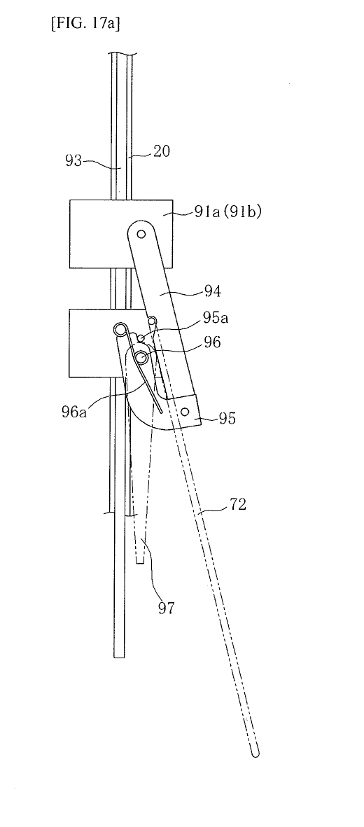

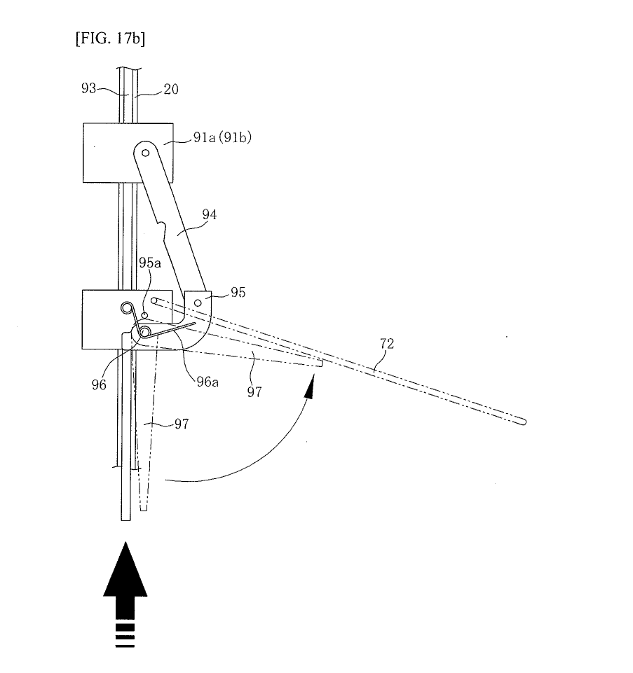

If it is necessary to protect the wind power generator A from the storm or to mend, manage and repair the wind power generator A, in order to stop the operation of the wing power generator A, the fixing means driving device 100′ is operated as shown in FIG. 14b, thus upwardly moving the moving shaft 93 of the windmill wing fixing means 90′ as shown in FIGS. 17b, 18b, and 19b. That is, when the motor 112′ is rotated in the normal direction, a rope 111 is wound to a shaft of the motor 112′, a spring 106′ is compressed, and a lower moving plate 105′ is lifted, so that a moving shaft 107′ is lifted and the lifted moving shaft 107′ upwardly moves the upper moving plate 110′.

The lifted upper moving plate 110′ upwardly moves the moving shaft 93, so that the moving units 91a and 91b fixed to the moving shaft 93 are lifted along the vertical rotating shaft 20, and thus the straight levers 94 are lifted. At this time, also a guide protrusion d is lifted along a guide groove 101a at a state that a lower switch contact point, which is not shown, is connected, and thus, at the state that the straight lever 94 is completely lifted, the fore-end of the guide protrusion d disconnects the upper switch contact point of a switch means, which is not shown, thus upwardly pulling the ‘L’-shaped levers 95. Thus, the rotation shafts 96 are rotated, so that the levers 97 lift the wing parts 72 of the windmill wings 70. Thus, the wing parts 72 of the entire windmill wings 70 maintain the horizontal state with respect to the ground not to receive the blowing wind (the state of FIGS. 14b,17b, 18b and 19b) and the rotation of the vertical rotating shaft 20 is stopped. In this situation, the wind power generator A can be mended, managed and repaired.

Here, differently from the case in which the operation of the wind power generator A is stopped by upwardly moving the moving shaft 93 completely, the angle of the vertical surface to the wing parts 72 of the windmill wings 70 can be set according to the degree of upwardly moving the moving shaft 93. In the event of a storm, the moving shaft 93 is upwardly moved and fixed in advance according to the predicted intensity of the storm, so that the wing parts 72 do not receive the entire wind, but make some of the wind pass by. As a result, the wind power generator A can be protected from the storm.

Moreover, the operation of the wind power generator A is stopped by upwardly moving the moving shaft 93 completely and then a worker for mending the wind power generator climbs up a ladder 60c to a working position, or goes up with a small-sized ladder on occasional demands and drapes the small-sized ladder between the horizontal support rods 40′ and then moves toward the working position, mounting the small-sized ladder.

Also, in order to lower and return the lifted moving shaft 93, the motor 112′ is rotated in the reverse direction. That is, when the motor 112′ is rotated in the reverse direction, the rope wound to the shaft of the motor 112′ is unwound and the lower moving plate 105′ is lowered by the elastic force of the spring 106′, so that the moving shaft 107′ is lowered and the upper moving plate 110′ is lowered.

Therefore, the lowering of the upper moving plate 110′ downwardly moves the moving shaft 93. At this time, also a guide protrusion d is lowered along a guide groove 101a and so an upper switch contact point, which is not shown, is connected. Through the lowering of the moving shaft 93, when the ends of the ‘L’-shaped lever 95 are suspended on the stopper pins 95a and does not rotated, the fore-end of the guide protrusion d disconnects the upper switch contact point of a switch means, which is not shown and thus the levers 97 moves downwardly and vertically. As a result, the wind power generator A reaches the state shown in FIGS. 14a, 17a, 18a, and 19a, i.e., the normal power generation state.

While the present invention has been illustrated and described in connection with the preferred embodiments, the present invention is not limited thereto. Accordingly, it will be understood by those skilled in the art that various modifications and changes can be made thereto without departing from the scope of the invention defined by the appended claims.

What is claimed is:

1. A variable windmill wing wind power generator having a power generation increasing means, comprising:
an installation mount stood on the floor in the shape of a cross and having a vertical rotating shaft holder in a central portion thereof;
a vertical rotating shaft rotatably and uprightly installed in the central portion of the installation mount;
a bearing into which a top end of the vertical rotating shaft is rotatably inserted;
‘[’-shaped holders connected and fixed between the bearing and the installation mount;
a plurality of inner wing installation units fixedly installed on the vertical rotating shaft at given intervals in the up/down direction;
support rods having one-side ends fixed to the inner wing installation units;
a plurality of outer wing installation units to which outer ends of the support rods are fixed;
support rings made of a steel wire and connected to the outer wing installation units on the same plane;
vertical support rods made of a steel wire and connecting the outer wing installation units of the same group in the up/down direction, the upper and lower outer wing installation units being grouped in the up/down multi-stage fashion;
a plurality of support bars made of a steel wire and connected between the highest support rod and the lowest support rod within the same group;
a plurality of diagonal support bars connected and fixed between upper and lower outer wing installation units within the same group;
a ladder fixed to the support rod of each stage;
windmill wings installed between the inner wing installation units and the outer wing installation units in the up/down multi-stage fashion;
support units installed on the vertical rotating shaft between the groups of the windmill wings made in the up/down multi-stage fashion, and connected to the ‘[’-shaped holders through wires;
windmill wing fixing means installed on the vertical rotating shaft above the inner wing installation units to be movable in the up/down direction and fixing displacements of the windmill wings;
fixing means driving device installed on the bottom end side of the vertical rotating shaft;
a power generation increasing means installed at the lower center portion of the installation mount so as to be changed the number of power generation turbines according to the strength of wind; and
a plurality of power generation means installed on the bottom portion of the power generation increasing means and for performing power generation.

2. The wind power generator of claim 1, wherein each of the inner wing installation units is divided into two installation units, which are coupled to each other by a bolt, the ends of the support rods are inserted into the inner wing installation unit in the horizontal direction from the front, rear, left and right directions and fixed thereto by a bolt downwardly inserted from the top surface, the ends of wing rotating shafts are rotatably inserted into the inner wing installation units on the same plane as the support rods, the ends of rotating shafts of the windmill wing fixing means are rotatably inserted into the inner wing installation units below the inserted portions of the support rods and the wing rotating shafts, the other ends of the support rods are inserted into and fixed to the outer wing installation units, and the respective other ends of the wing rotating shafts and the rotating shafts are rotatably inserted into the outer wing installation units.

3. The wind power generator of claim 2, wherein the inner wing installation units are divided into a structure in which the cutting side of the central portion for dividing the installation unit into tow is parallel to the outer side and a structure in which the cutting side for dividing the installation unit into two is diagonal, and employed for each group of the windmill wings made in the up/down multi-stage fashion.

4. The wind power generator of claim 1, wherein each of the windmill wings comprises:
a wing rotating shaft rotatably installed between the inner wing installation unit and the outer wing installation unit on the same plane as the support rod;
a wing part having one side fixed to the wing rotating shaft; and
a wing spring inserted into a central portion of the wing rotating shaft and maintaining the wing part 45 degree from the horizontal surface during non-operation.

5. The wind power generator of claim 4, wherein the wing rotating shafts located on the same plane within the same group are connected with plural steel wire support bars, plural steel wire support bars are connected and fixed between the support ring, and also a support bar 60c and a support bar 60d, and a support bar 60f and a support ring 60 are connected with each other.

6. The wing power generator of claim 4, wherein the wing parts are made of any one selected from the group consisting of transparent or opaque reinforced plastic, strengthened glass, non-ferrous metal, and duralumin.

7. The wing power generator of claim 1, wherein each of the support units is divided into two support bodies, which are coupled to each other by a bolt, support plates are inserted into bottom circular projection portions formed by the coupling of the support bodies, each of the support plates is divided into two support plates so that one support plate forms a hinge structure and the other support plate is coupled to a bolt through the medium of a bracket, the ends of the wires are fixed to four edges of the coupled support plates, and the other ends of the wires are connected and fixed to the ‘[’-shaped holders.

8. The wind power generator of claim 1, wherein each of the windmill wing fixing means is divided into two moving units, which are coupled to each other by a bolt so that the moving units can move in the up/down direction with the vertical rotating shaft inserted into a central portion thereof, a moving shaft for moving the moving units in the up/down direction is inserted and fixed between two moving units, the ends of the straight lever are fixed to outer surfaces of the two coupled moving units, respectively, the ends of ‘L’-shaped levers are rotatably connected to the other ends of the straight levers, rotating shafts provided with springs are inserted into the other ends of the ‘L’-shaped levers and rotatably inserted into the inner wing installation units, stopper pins for stopping rotation of the ‘L’-shaped levers are inserted into and fixed to the inner wing installation units on which the other ends of the ‘L’-shaped levers are located, the springs have the ends mounted on and fixed to the support rods and the other ends fixed on the ‘L’-shaped levers adjacent to the connection portions of the straight levers and the ‘L’-shaped levers, and a plurality of levers are fixed on the rotating shafts at given intervals.

9. The wind power generator of claim 8, wherein the two moving units have a structure in which the cutting side of the central portion for dividing the moving unit into two is parallel to the outer side, two moving units having a structure in which the cutting side is diagonal are further provided, the moving units of the parallel structure are employed for one group of the windmill wings made in the up/down multi-stage fashion, and the moving units of the diagonal structure are employed for the other group.

10. The wind power generator of claim 1, wherein the fixing means driving device comprises:
a rectangular box body;
a lower fixing plate fixed to a lower portion in the rectangular box body;
a pair of rollers installed at a lower side of the lower fixing plate;
lower rollers installed at every lower side corner of the lower fixing plate;
a lower moving plate moved upwardly and downwardly in the rectangular box body;
a spring inserted into the upper side center of the lower moving plate;
a plurality of moving shafts fixed uprightly at the corner of the lower moving plate;
an upper fixing plate fixed to an upper portion in the rectangular box body;
upper rollers installed at every lower side corner of the upper fixing plate;
an upper moving plate fixed at an upper end of a plurality of moving shafts;
a rope means comprising ropes which is hung the rollers and upper and lower rollers; and
a motor for winding and unwinding the rope means.

11. The wind power generator of claim 10, wherein the rectangular box body includes a guide groove having oblong shapes at upper and lower portions thereof, formed at a side of the rectangular body, the lower fixing plate is fixed to a lower portion of the rectangular box body by a ‘┐’-shaped bracket, the rollers are fixed to a lower side of the lower fixing plate by a bracket, the lower end of the moving shaft is fixed to the corner of the lower moving plate by nuts and the upper end of the moving shaft is fixed to the upper moving plate by nuts, a guide member having a guide protrusion is fixed at an upper side end of the lower moving plate and the guide protrusion is inserted into the guide groove, a fixing bolt is formed at a side of the upper fixing plate and inserted and fixed into a side of the rectangular box body, and an upper roller is fixed to a lower side of the upper fixing plate by a bracket.

12. The wind power generator of claim 1, wherein the power generation efficiency increasing means comprises:
a circular plate shape switch driving means installed at a support shaft, which installed uprightly and separately adjacent to the vertical rotating shaft, by a bracket;
a rudder connected and installed to the switch driving means, wherein it is rotated according to the wind blowing direction to receive the wind direction frontally;
a switch having a wind receiving wing which is installed at a lower portion of the switch driving means and turned on or off according to the strength of wind;
a driving gear connected with a lower end of the vertical rotating shaft within a housing equipped to a lower end portion of the vertical rotating shaft;
a first driven gear engaged with the driving gear;
a second and a third driven gears installed adjacent to the driving gear and engaged with the driving gear according to the strength of wind; and
an air compressor for pushing all or any one among the first to the third driven gears to the driving gear through the respective linear actuators according to the contact point state of the switch so as to be engaged with the driving gear.

13. The wind power generator of claim 12, wherein the switch comprises a wind receiving wing, a right side contact roller contacted to the right outer circumferential edge of the switch driving means, and a left side contact roller contacted to the left outer circumferential edge of the switch driving means, wherein when the strength of wind becomes the constant strength, the right outer circumferential edge of the switch driving means pushes the right contact roller and is switched, and when the strength of wind becomes stronger, the left outer circumferential edge of the switch driving means pushes the left contact roller and is switched.

14. The wind power generator of claim 1, wherein the power generation means comprises power generators installed at the lower portions of the first to third driven gears engaged with the driving gear, respectively.

15. The wind power generator of claim 1, wherein the windmill wings are installed in the up/down n-stage, the wind power generator having the up/down n-stage windmill wings is installed in a plural number in the front/rear and left/right horizontal directions, and the power generation means of the respective wind power generations are electrically connected with each other, so that power generated by each power generation means is combined.

16. The wind power generator of claim 15, wherein when the plurality of wind power generators having the up/down n-stage windmill wings are installed in the front/rear and left/right horizontal directions, a plurality of pillars are vertically installed on front/rear and left/right outer portions, and connected and fixed to the bearing portions of the respective wind power generators by wires.
